(19) United States
(12) Patent Application Publication
(10) Pub. No.: US 2002/0176694 A1
(43) Pub. Date: Nov. 28, 2002

(54) Optical disc reproducing apparatus

(75) Inventor: Yoshiki Kondo, Osaka (JP)

Correspondence Address: MORGAN LEWIS & BOCKIUS LLP, 1111 PENNSYLVANIA AVENUE NW, WASHINGTON, DC, 20004, US

(73) Assignee: FUNAI ELECTRIC CO., LTD

(21) Appl. No.: 10/147,053

(22) Filed: May 17, 2002

(30) Foreign Application Priority Data
May 22, 2001 (JP) P 2001-152619

(51) Int. Cl. H04N 5/781

(52) U.S. Cl. 386/95; 386/126

(57) ABSTRACT

In an optical disc reproducing apparatus which reproduces a video signal recorded on an optical disc, a character data is input and stored while cyclically changing a plurality of characters each time when one of the keys is pressed, and the stored character data is displayed on a screen of a monitoring device in synchronization with an image which is repetitively reproduced, a previously designated image, or an image which is reproduced in conjunction with switching of optical discs. The input character data can be converted into a desired kanji data.

### BACKGROUND OF THE INVENTION

The present invention relates to an optical disc reproducing apparatus which reproduces a DVD (Digital Video Disc), and more particularly to an optical disc reproducing apparatus which displays an input character data in synchronization with a reproduced image.

A conventional technique of displaying a character data with being superimposed on a video signal, and in synchronization with a reproduced image is disclosed in, for example, the Unexamined Japanese Patent Application Publication No.Hei-150713. According to the disclosed technique, in a music word reproducing apparatus for reproducing a recording medium on which music data and word data are recorded, to enjoy singing, when the user is to sing a song in which the user does not know the words and melody of some of the verses, a verse which the user knows well is designated, whereby only the word data are reconstructed without changing the configuration of the whole song. In accordance with the performance of the song, only words of the designated verse are repetitively displayed, so that the user can sing the entire portion of the song.

In the conventional technique, the word data of a verse designated by the user can be reconstructed, and, in accordance with the performance of the song, only the words of the designated verse can be repeatedly displayed. However, the technique has a problem in that the user cannot input a character data to be displayed so that an input character data is displayed in synchronization with a reproduced image.

### SUMMARY OF THE INVENTION

The invention is conducted in view of the problem. It is an object of the invention to provide an apparatus in which the user can input a character data to be displayed, and the input character data is transmitted to a monitoring device with being superimposed on a video signal, so that the input character data is displayed on a screen of the monitoring device in synchronization with a reproduced image.

In order to attain the object, according to the invention, in an optical disc reproducing apparatus which reproduces a video signal recorded on an optical disc, the apparatus comprises: inputting section for inputting a character data; storage section for storing the character data which is input by the inputting section; and display controlling section for displaying the character data which is stored in the storage section, and the character data which is stored in the storage section is displayed in synchronization with a reproduced image.

A character data may be input by pressing a plurality of input keys which are disposed on a remote control device or an operation panel, a table in which a plurality of characters are allocated to each of the keys may be disposed, and a character data may be input while, each time when one of the keys is pressed, the characters allocated in the table are cyclically changed.

The apparatus may further comprise kanji converting section for converting the character data which is input by the inputting section, into a kanji data, thereby enabling the character data which is input by the inputting section to be converted into a desired kanji data.

The display controlling section may display a character data which is being input by the inputting section, and the character data which is stored in the storage section, at different positions, and the character data which is stored in the storage section may be scroll-displayed in synchronization with an image which is repetitively reproduced, a previously designated image, or an image which is reproduced in conjunction with switching of optical discs.

According to these section, it is possible to provide an apparatus in which the user can input a character data to be displayed, and the input character data is transmitted to a monitoring device with being superimposed on a video signal, so that the input character data is displayed on a screen of the monitoring device in synchronization with a reproduced image.

### BRIEF DESCRIPTION OF THE DRAWINGS

FIG. 1 is a block diagram showing the configuration of an optical disc reproducing apparatus of an embodiment of the invention.

FIGS. 2A and 2B are diagrams showing display positions of a character data in the optical disc reproducing apparatus of the embodiment of the invention.

FIG. 3 is a view showing a remote control device of the optical disc reproducing apparatus of the embodiment of the invention.

FIG. 4 is a diagram showing an input character table of the remote control device of the optical disc reproducing apparatus of the embodiment of the invention.

FIG. 5 is a flowchart showing an operation of displaying a character data in the optical disc reproducing apparatus of the embodiment of the invention.

FIGS. 6A to 6C are diagrams showing an operation of displaying a character data in the optical disc reproducing apparatus of the embodiment of the invention.

### DETAILED DESCRIPTION OF THE PREFERRED EMBODIMENTS

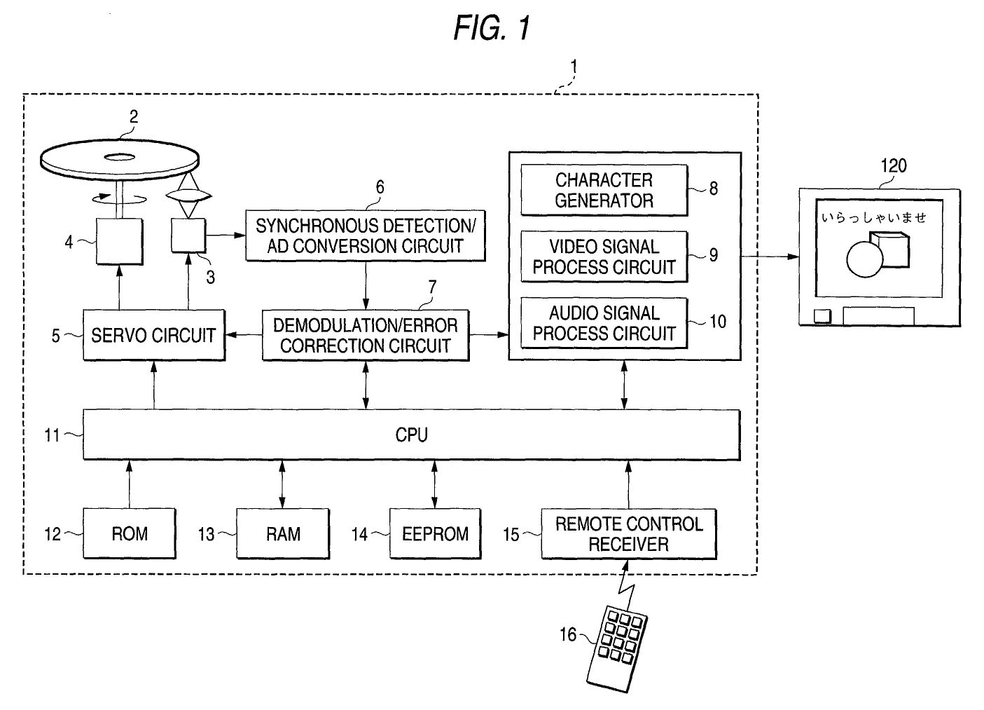

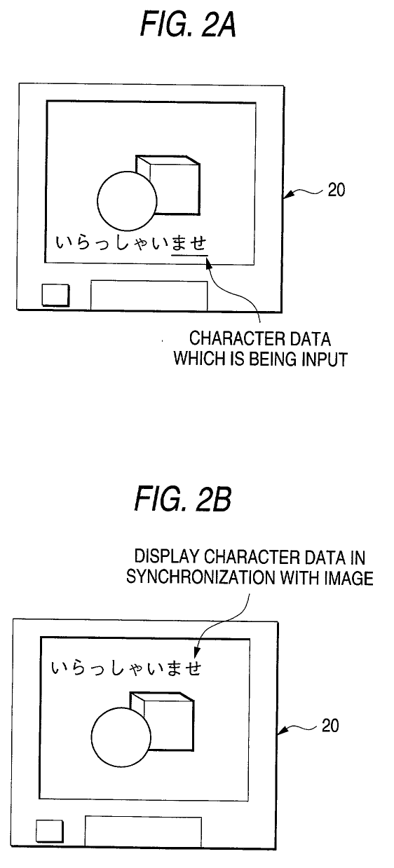

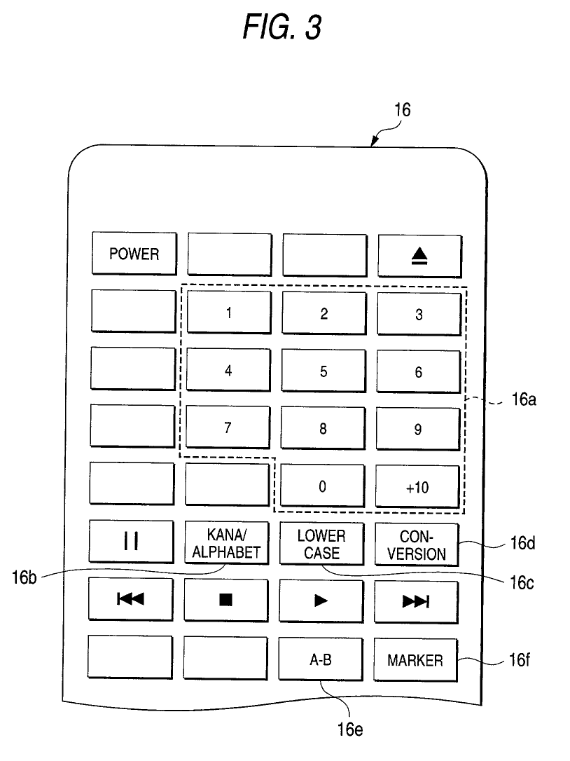

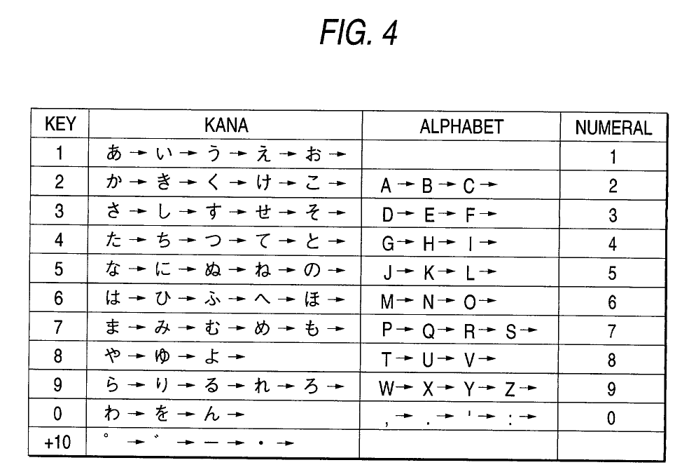

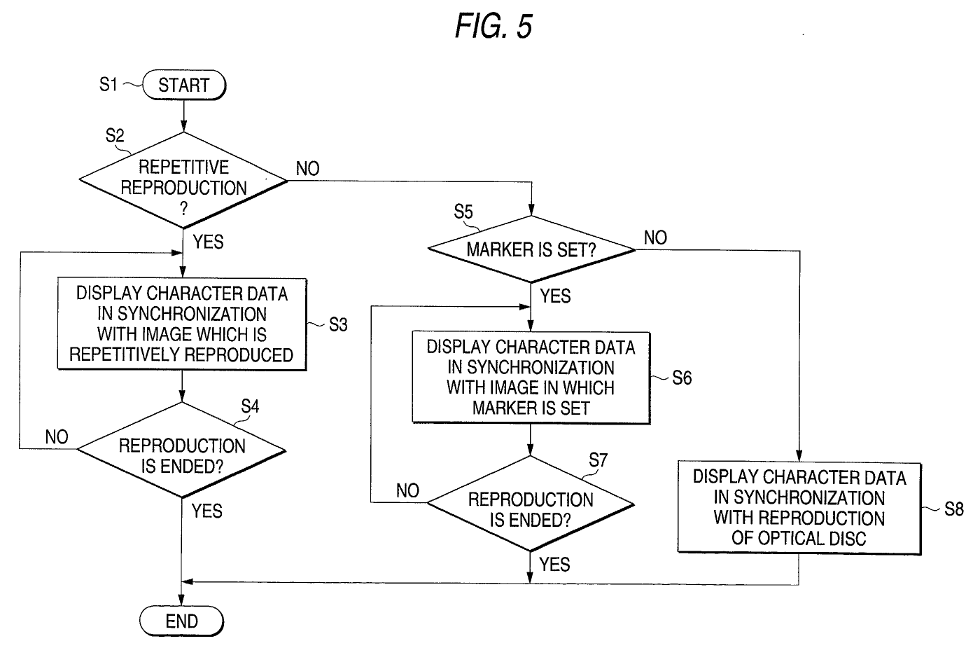

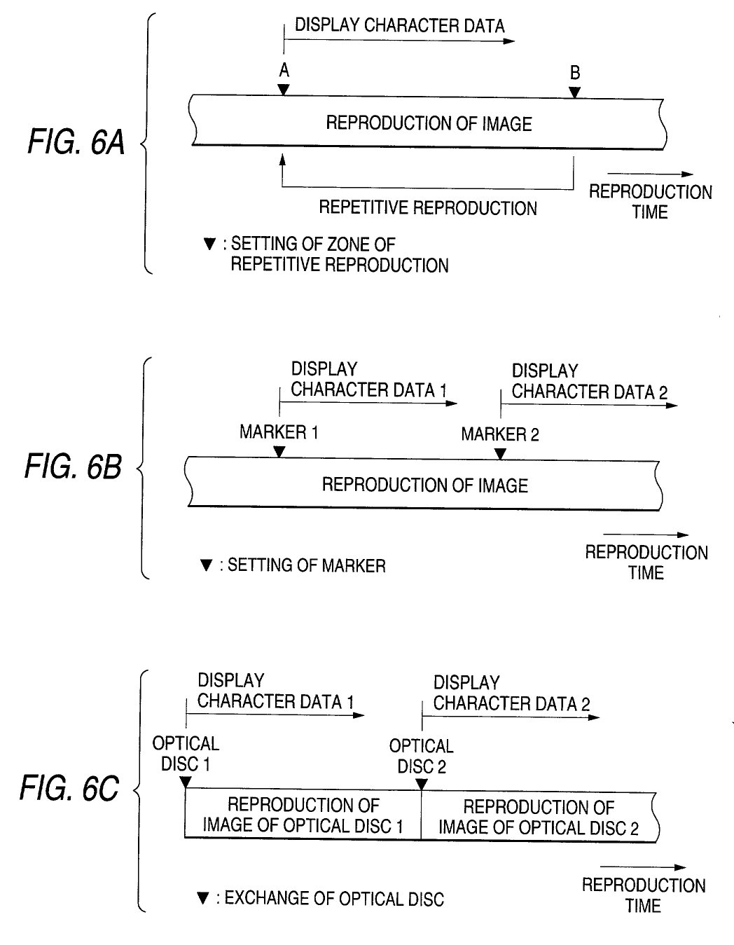

Hereinafter, an embodiment of the invention will be described in detail while suitably referring to the accompanying drawings. FIG. 1 is a block diagram showing the configuration of an optical disc reproducing apparatus of an embodiment of the invention, FIG. 2 is a diagram showing display positions of a character data in the optical disc reproducing apparatus of the embodiment of the invention, FIG. 3 is a view showing a remote control device of the optical disc reproducing apparatus of the embodiment of the invention, FIG. 4 is a diagram showing an input character table of the remote control device of the optical disc reproducing apparatus of the embodiment of the invention, FIG. 5 is a flowchart showing an operation of displaying a character data in the optical disc reproducing apparatus of the embodiment of the invention, and FIG. 6 is a diagram showing an operation of displaying a character data in the optical disc reproducing apparatus of the embodiment of the invention.

First, description will be made with reference to the block diagram of FIG. 1 showing the configuration of an optical disc reproducing apparatus of an embodiment of the invention.

A video signal recorded on an optical disc 2 such as a DVD is optically read by an optical pickup 3 of the optical disc reproducing apparatus 1. A servo circuit 5 is a control circuit which performs a focusing control and a tracking control on the optical pickup 3, and a CLV (Constant Linear Velocity) rotation control on a spindle motor 4 that rotates the optical disc.

The video signal which is read by the optical pickup 3 is sent to a synchronous detection/AD (Analog-Digital) conversion circuit 6, so that the signal is amplified and then subjected to synchronous detection based on a reference clock, and the analog signal is converted into a digital signal. The video signal which has been converted into a digital signal is sent to a demodulation/error correction circuit 7, so that the signal is demodulated and an error of the data of the video signal read by the optical pickup 3 is corrected.

The video signal which has undergone the error correction in the demodulation/error correction circuit 7 is separated into a video signal and an audio signal. The signals are sent to a video signal process circuit 9 and an audio signal process circuit 10, respectively.

The video signal sent to the video signal process circuit 9 is decoded by the video signal process circuit 9, and then coded to a video signal according to a predetermined signal system such as the NTSC (National Television System Committee) system. The resulting digital signal is converted into an analog signal, and thereafter supplied as a video signal to a monitoring device 20.

The audio signal sent to the audio signal process circuit 10 is decoded by the audio signal process circuit 10. The resulting digital signal is converted into an analog signal, and thereafter supplied to the monitoring device 20 which is connected to the optical disc reproducing apparatus 1.

In the video signal which has undergone the error correction in the demodulation/error correction circuit 7, a control signal for controlling the system, and control and information signals which are reproduced by the video signal process circuit 9 and the audio signal process circuit 10 are sent to a central processing unit (CPU) 11 which controls the whole system of the optical disc reproducing apparatus 1.

To the CPU 11, connected are a ROM (Read-Only Memory) 12 which stores control programs for controlling the system of the optical disc reproducing apparatus 1, a RAM (Random Access Memory) 13 which temporarily stores process data and the like, an EEPROM (Electrically Erasable and Programmable Read-Only Memory) 14 which stores a character data input by the user, and a remote control receiver 15 which receives an instruction signal produced by a key operation on a remote control device 16.

The CPU 11 receives through the remote control receiver 15 the instruction signal sent from the remote control device 16, and sends a control signal to the servo circuit 5, the video signal process circuit 9, and the audio signal process circuit 10, to control the system of the optical disc reproducing apparatus 1.

Furthermore, the CPU 11 performs the following controls. A signal of a character data which is input by a key operation conducted by the user on the remote control device 16 is received by the remote control receiver 15. The received character data is stored into the EEPROM 14. The character data stored in the EEPROM 14 is sent to a character generator 8 on the basis of a display style which is set by the user. The resulting character data is superimposed on the video signal, to be displayed on the screen of the monitoring device 20 in synchronization with a reproduced image.

When a character data which is being input by a key operation on the remote control device 16 is to be displayed on the screen of the monitoring device 20, in order to clarify that the character data is being input, the character data which is being input, and the character data stored in the EEPROM 14 are preferably displayed at different positions in the screen of the monitoring device 20.

For example, the character data which is being input by a key operation on the remote control device 16 may be displayed in a lower portion of the screen of the monitoring device 20 as shown in FIG. 2A, and the character data stored in the EEPROM 14 may be displayed in synchronization with a reproduced image as shown in FIG. 2B.

In the character data which is being input and displayed on the screen of the monitoring device 20, characters which have not yet been determined may be displayed with being underscored.

Preferably, scrolling is employed as the style of displaying the character data stored in the EEPROM 14. When the scroll displaying of a character data is employed, a lengthy character data can be continuously displayed on the screen of the monitoring device 20.

When a character data is scroll-displayed on the screen of the monitoring device, a desired portion or the entire of the character data may be displayed with being blinked or reversed.

Next, description will be made on the basis of the view of FIG. 3 showing the remote control device of the optical disc reproducing apparatus of the embodiment of the invention, and with reference to the diagram of FIG. 4 showing an input character table of the remote control device of the optical disc reproducing apparatus of the embodiment of the invention.

As shown in FIG. 3, in the remote control device 16, various keys including: a power source key which transmits a signal for turning on and off the power source of the optical disc reproducing apparatus 1; reproduction, stop, pause, fast forward, and fast reverse keys which transmit a reproduction control signal of an optical disc; ten keys for selecting a title/chapter; and the like are disposed. The optical disc reproducing apparatus 1 can be operated as desired by operating these keys.

When a kana/alphabet key 16b of the remote control device 16 is pressed, each key of the ten keys 16a is switched to a character input key so as to enable a kana, an alphabet, or a numeral to be input. The ten keys 16a of the remote control device 16 are configured so that, each time when one of the keys is pressed, an input character candidate can be cyclically selected as shown in FIG. 4.

In the case where the kana input mode is selected by operating the kana/alphabet key 16b, for example, the input character candidate is cyclically changed in the sequence of “ [symbol] → [symbol] → [symbol] → [symbol] → [symbol] → [symbol] ” each time when the “1” key of the ten keys 16a is pressed, thereby enabling the user to select one of the input character candidates. In the case where “alphabet” input mode is selected, the input character candidate is cyclically changed in the sequence of “A→B→C→A” each time when the “1” key is pressed, thereby enabling the user to select one of the input character candidates. In the case where “numeral” input mode is selected, numeral “1” is input when the “1” key is pressed.

A lower case key 16c of the remote control device 16 is used for changing the input kana to a double consonant character, and “+10” key of the ten keys 16s is used for changing the input kana to a sonant character or a p-sound character.

When a conversion key 16d of the remote control device 16 is pressed, an input character data can be converted into a desired kanji data. A kanji data of the next candidate can be selected each time when the key is pressed.

For example, a case where a character data of “ [symbol] (This Japanese phrase corresponds to “May I help you?” in English)” is to be input will be described. The input mode is changed to the kana input mode by pressing the kana/alphabet key 16b. The “1” key of the ten keys 16s is pressed two times to input “ [symbol] ”. The “9” key of the ten keys 16s is pressed once to input “ [symbol] ”. The “4” key of the ten keys 16s is pressed three times to input “ [symbol] ”, and the lower case key is pressed to change “ [symbol] ” to a lower case or “ [symbol] ”. The “3” key of the ten keys 16s is pressed two times to input “ [symbol] ”. The “8” key of the ten keys 16s is pressed once to input “ [symbol] ”, and the lower case key is pressed to change “ [symbol] ” to a lower case or “ [symbol] ”. The “1” key of the ten keys 16s is pressed two times to input “ [symbol] ”. The “7” key of the ten keys 16s is pressed once to input “ [symbol] ”. The “3” key of the ten keys 16s is pressed four times to input “ [symbol] ”.

For example, another case where a character data of “ [symbol] (This Japanese phrase corresponds to “We thank you for your patronage” in English)” is to be input will be described. In a manner similar to that described above, “ [symbol] is input by pressing predetermined ones of the ten keys 16a. Thereafter, the conversion key 16d is pressed to convert the input character data into a kanji data. In a manner similar to that described above, “ [symbol] ” is then input by pressing predetermined ones of the ten keys 16a.

The display style of an input character data can be set by an A-B key 16e and a marker key 16f of the remote control device 16.

The A-B key 16e of the remote control device 16 is a key for setting an image to be repetitively reproduced while designating the zone of repetitive reproduction. When repetitive reproduction is set, the input character data is displayed in synchronization with an image which is repetitively reproduced.

The marker key 16f of the remote control device 16 is a key for setting a marker in an image which is being reproduced. When a marker is set, the input character data is displayed in synchronization with an image in which the marker is set.

When the above-mentioned repetitive reproduction or marker is not set, the input character data is displayed in synchronization with the beginning of reproduction of an optical disc. In the case of an optical disc reproducing apparatus of the autochanger type in which a plurality of optical discs are continuously reproduced, the input character data may be displayed in synchronization with an image which is reproduced in conjunction with switching of optical discs.

The plurality of keys disposed on the above-mentioned remote control device may be disposed on the operation panel of the optical disc reproducing apparatus.

Next, description will be made on the basis of the flowchart of FIG. 5 showing an operation of displaying a character data in the optical disc reproducing apparatus of the embodiment of the invention, and with reference to the diagram of FIG. 6 showing an operation of displaying a character data in the optical disc reproducing apparatus of the embodiment of the invention.

When reproduction of an optical disc is started, the control proceeds from step S1 to step S2 to judge whether repetitive reproduction is set or not. If repetitive reproduction is set, the control proceeds to step S3. If repetitive reproduction is not set, the control proceeds to step S5.

In step S3, as shown in FIG. 6A, a character data is displayed in synchronization with an image which is reproduced from a position A where repetitive reproduction is to be started, and the image is reproduced until a position B where the repetitive reproduction is to be ended. Then, the control proceeds to step S4.

In step S4, it is judged whether the reproduction of the optical disc is to be ended or not. If the reproduction of the optical disc is to be ended, the control proceeds to step S9 to end the process. If the reproduction of the optical disc is not to be ended, the control returns to step S3, and repeats steps S3 and S4, so that a character data is displayed in synchronization with an image which is repetitively reproduced.

In step 5, it is judged whether a marker is set in the image to be reproduced or not. If a marker is set in the image to be reproduced, the control proceeds to step S6. If a marker is not set in the image to be reproduced, the control proceeds to step S8.

In step S6, as shown in FIG. 6B, a character data 1 is displayed in synchronization with an image in which a marker 1 is set. The control then proceeds to step S7.

In step S7, it is judged whether the reproduction of the optical disc is to be ended or not. If the reproduction of the optical disc is to be ended, the control proceeds to step S9 to end the process. If the reproduction of the optical disc is not to be ended, the control returns to step S6. In step S6, as shown in FIG. 6B, the next character data 2 is displayed in synchronization with an image in which the next marker 2 is set. Then, steps S6 and S7 are repeated until the reproduction of the optical disc is ended, so that an input character data is displayed for each of images in which a marker is set.

In step S8, as shown in FIG. 6C, the character data 1 is displayed in synchronization with the reproduction of the optical disc 1. When the reproduction of the optical disc 1 is ended, the control proceeds to step S9 to end the process.

When reproduction of another optical disc is started, the process from step S1 to step S9 is again repeated. If repetitive reproduction or a marker is not set, the process proceeds from step S1 to step S8, and the next character data 2 is displayed in synchronization with the reproduction of the next optical disc 2 as shown in FIG. 6C.

In the case of an optical disc reproducing apparatus of the autochanger type in which a plurality of optical discs are continuously reproduced, a character data to be displayed for each of the optical discs may be previously input and stored, thereby enabling character data respectively corresponding to the optical discs to be sequentially displayed in synchronization with an image which is reproduced in conjunction with switching of the optical discs.

As described above, according to the optical disc reproducing apparatus of the invention, a character data can be input while a plurality of characters are cyclically changed by pressing a plurality of input keys disposed on a remote control device or an operation panel, the input character data can be stored after it is converted into a desired kanji data, and the stored character data can be displayed on a screen of a monitoring device in synchronization with an image which is repetitively reproduced, a previously designated image, or an image which is reproduced in conjunction with switching of optical discs. According to the configuration, the user can input a character data to be displayed, and the input character data is transmitted to a monitoring device with being superimposed on a video signal, so that the input character data is displayed on the screen of the monitoring device in synchronization with a reproduced image.

In the optical disc reproducing apparatus according to the first aspect of the invention, a character data is input while a plurality of characters are cyclically changed by pressing a plurality of input keys disposed on a remote control device or an operation panel, the input character data is converted into a desired kanji data and then stored, and the stored character data is displayed in one of display styles including scrolling, blinking, reversal, and combinations of the display styles, in synchronization with an image which is repetitively reproduced, a previously designated image, or an image which is reproduced in conjunction with switching of optical discs. A character data which is being input, and the stored character data are displayed at different positions.

In the optical disc reproducing apparatus according to the second aspect of the invention, the input character data can be stored, and the stored character data can be displayed in synchronization with a reproduced image.

In the optical disc reproducing apparatus according to the third aspect of the invention, a character data can be input while a plurality of characters are cyclically changed by pressing the plurality of input keys disposed on a remote control device or an operation panel.

In the optical disc reproducing apparatus according to the fourth aspect of the invention, an input character data can be converted into a desired kanji data.

In the optical disc reproducing apparatus according to the fifth aspect of the invention, a character data which is being input, and the stored character data are displayed at different positions.

In the optical disc reproducing apparatus according to the sixth aspect of the invention, a character data is displayed in synchronization with an image which is repetitively reproduced.

In the optical disc reproducing apparatus according to the seventh aspect of the invention, a character data is displayed in synchronization with a previously designated image.

In the optical disc reproducing apparatus according to the eighth aspect of the invention, a character data is displayed in synchronization with an image which is reproduced in conjunction with switching of optical discs.

In the optical disc reproducing apparatus according to the ninth aspect of the invention, a character data is displayed in one of display styles including scrolling, blinking, reversal, and combinations of the display styles.

What is claimed is:

1. An optical disc reproducing apparatus which reproduces a video signal recorded on an optical disc, comprising:
inputting section, including a plurality of input keys disposed on a remote control device or an operation panel, and having a table in which a plurality of characters are allocated to each of said keys, for inputting a character data while, each time when one of said keys is pressed, cyclically changing the characters allocated in said table;
kanji converting section for converting the character data which is input by said inputting section, into a desired kanji data;
storage section for storing the character data which is input by said inputting section; and
display controlling section for displaying character data, and for displaying a character data which is being input by said inputting section, and the character data which is stored in said storage section, at different positions, wherein
the character data which is stored in said storage section is displayed in one of display styles including scrolling, blinking, reversal, and combinations of the display styles, in synchronization with an image which is repetitively reproduced, a previously designated image, or an image which is reproduced in conjunction with switching of optical discs.

2. An optical disc reproducing apparatus which reproduces a video signal recorded on an optical disc, comprising:
inputting section for inputting a character data;
storage section for storing the character data which is input by said inputting section; and
display controlling section for displaying the character data which is stored in said storage section, in a predetermined display style, wherein
the character data which is stored in said storage section is displayed in synchronization with a reproduced image.

3. The optical disc reproducing apparatus according to claim 2, wherein
said inputting section includes a plurality of input keys which are disposed on a remote control device or an operation panel, which have a table in which a plurality of characters are allocated to each of said keys, and through which a character data is input while, each time when one of said keys is pressed, the characters allocated in said table are cyclically changed.

4. The optical disc reproducing apparatus according to claim 2, further comprising:
kanji converting section for converting the character data which is input by said inputting section, into a kanji data, to enable the character data which is input by said inputting section to be converted into a desired kanji data.

5. The optical disc reproducing apparatus according to claim 2, wherein
said display controlling section displays a character data which is being input by said inputting section, and the character data which is stored in said storage section, at different positions.

6. The optical disc reproducing apparatus according to claim 2, wherein
said display controlling section displays the character data which is stored in said storage section, in synchronization with an image which is repetitively reproduced.

7. The optical disc reproducing apparatus according to claim 2, wherein
said display controlling section displays the character data which is stored in said storage section, in synchronization with a previously designated image to be reproduced.

8. The optical disc reproducing apparatus according to claim 2, wherein
said display controlling section displays the character data which is stored in said storage section, in synchronization with an image which is reproduced in conjunction with switching of optical discs.

9. The optical disc reproducing apparatus according to claim 2, wherein
said display controlling section displays the character data which is stored in said storage section, in one of display styles including scrolling, blinking, reversal, and combinations of the display styles.
